(19) United States
(12) Patent Application Publication
(10) Pub. No.: US 2025/0370801 A1
(43) Pub. Date: Dec. 4, 2025

(54) MEMORY MANAGEMENT METHOD AND APPARATUS, MEDIUM, AND ELECTRONIC DEVICE

(71) Applicants: Beijing Volcano Engine Technology Co., Ltd., Beijing (CN); Lemon Inc., Grand Cayman (KY)

(72) Inventors: Yifei Zhang, Beijing (CN); Chuansheng Lu, Beijing (CN); Xiangdong Ji, Beijing (CN); Deyu Wang, Beijing (CN); Tianxiao Gu, Culver City, CA (US)

(21) Appl. No.: 18/874,046

(22) PCT Filed: Aug. 30, 2023
(86) PCT No.: PCT/CN2023/115923

§ 371 Date: Dec. 11, 2024

(30) Foreign Application Priority Data
Oct. 26, 2022 (CN) 2022113213922

(51) Int. Cl. G06F 9/50; G06F 13/16

(52) U.S. Cl. CPC G06F 9/5016; G06F 9/5044; G06F 13/1673

(57) ABSTRACT

A memory management method, comprising: obtaining a target object to which memory is to be allocated in a target thread; determining, based on reference of the target object to another object, a memory allocation policy corresponding to the target object, the memory allocation policy comprising a first policy and a second policy, the first policy indicating to allocate, in an allocation buffer of heap memory, memory of a corresponding size to the target object, and the second policy indicating to allocate, in the heap memory, memory of a corresponding size to the target object; and allocating, based on the memory allocation policy corresponding to the target object, memory to the target object in a target allocation buffer corresponding to the target thread or in the heap memory, the target allocation buffer being configured to allocate memory to a plurality of objects in the target thread corresponding to the first policy.

### CROSS-REFERENCE TO RELATED APPLICATION(S)

The present application claims priority to Chinese Patent Application No. 202211321392.2, filed with the China National Intellectual Property Administration on Oct. 26, 2022, and entitled “MEMORY MANAGEMENT METHOD AND APPARATUS, MEDIUM, AND ELECTRONIC DEVICE”, the disclosure of which is incorporated herein by reference in its entirety.

### FIELD

The present disclosure relates to the field of computer technologies, and in particular, to a memory management method and apparatus, a medium, and an electronic device.

### BACKGROUND

In the field of computer technologies, memory management is an important measure for ensuring efficient and stable operation of a computer. Memory management may include a plurality of parts, such as memory resource allocation and memory resource recollection. However, the memory management methods in the related art have a problem of low memory allocation speed.

### SUMMARY

The Summary is to introduce the concepts in a simplified form, which will be described in detail in the following Detailed Description of Embodiments. The Summary is not intended to identify the key feature(s) or essential feature(s) of the claimed technical solutions, nor is it intended to be used to limit the scope of the claimed technical solutions.

According to a first aspect, the present disclosure provides a memory management method. The method includes:
obtaining a target object to which memory is currently to be allocated in a target thread;
determining, based on reference of the target object to another object, a memory allocation policy corresponding to the target object, where the memory allocation policy includes a first policy and a second policy, the first policy indicates to allocate, in an allocation buffer of heap memory, memory of a corresponding size to the target object, and the second policy indicates to allocate, in the heap memory, memory of a corresponding size to the target object; and
allocating, based on the memory allocation policy corresponding to the target object, memory to the target object in a target allocation buffer corresponding to the target thread or in the heap memory, where the target allocation buffer is configured to allocate memory to a plurality of objects in the target thread corresponding to the first policy.

According to a second aspect, the present disclosure provides a memory management apparatus. The apparatus includes:
a first obtaining module, configured to obtain a target object to which memory is currently to be allocated in a target thread;
a first determining module, configured to determine, based on reference of the target object to another object, a memory allocation policy corresponding to the target object, where the memory allocation policy includes a first policy and a second policy, the first policy indicates to allocate, in an allocation buffer of heap memory, memory of a corresponding size to the target object, and the second policy indicates to allocate, in the heap memory, memory of a corresponding size to the target object; and
an allocating module, configured to allocate, based on the memory allocation policy corresponding to the target object, memory to the target object in a target allocation buffer corresponding to the target thread or in the heap memory, where the target allocation buffer is configured to allocate memory to a plurality of objects in the target thread corresponding to the first policy.

According to a third aspect, the present disclosure provides a computer-readable medium having a computer program stored thereon, where computer program, when executed by a processing unit, implements the steps of the method described in the first aspect.

According to a fourth aspect, the present disclosure provides an electronic device, including:
a storage having a computer program stored thereon; and
a processing unit configured to execute the computer program in the storage, to implement the steps of the method described in the first aspect.

According to the above technical solutions, the target object to which memory is currently to be allocated in the target thread is obtained, the memory allocation policy corresponding to the target object is determined based on reference of the target object to another object, and memory is allocated, based on the memory allocation policy corresponding to the target object, to the target object in the target allocation buffer corresponding to the target thread or in the heap memory. In this way, in addition to directly allocating, in the heap memory, memory of a corresponding size to the target object, a larger piece of memory may be requested in the heap memory, and the memory is used to allocate memory to a plurality of objects in the target thread corresponding to the first policy. Therefore, the process of allocating memory to the plurality of objects in the target thread corresponding to the first policy can be completed by requesting the target allocation buffer for one time, so that the number of times of requesting memory from an operating system or a memory management system at a lower layer can be reduced, and CPU usage of code related to memory management can be reduced. In addition, the memory allocation speed is improved, and the memory management efficiency is improved.

In addition, because the first policy is for allocating memory in the allocation buffer in the heap memory, the first policy may be considered as a fast path of the second policy, and the object memory allocation speed can be further improved.

Other features and advantages of the present disclosure will be described in detail in the following Detailed Description of Embodiments.

### BRIEF DESCRIPTION OF THE DRAWINGS

The above and other features, advantages, and aspects of embodiments of the present disclosure become more apparent with reference to the following specific implementations and in conjunction with the accompanying drawings. Throughout the drawings, the same or similar reference numerals denote the same or similar elements. It should be understood that the accompanying drawings are schematic and that parts and elements are not necessarily drawn to scale. In the drawings:

FIG. 1 is a flowchart of a memory management method according to an exemplary embodiment of the present disclosure.

FIG. 2 is a schematic diagram of a structure of an object allocated in an allocation buffer according to an exemplary embodiment of the present disclosure.

FIG. 3 is a block diagram of a memory management apparatus according to an exemplary embodiment of the present disclosure.

FIG. 4 is a schematic diagram of a structure of an electronic device according to an exemplary embodiment of the present disclosure.

### DETAILED DESCRIPTION OF EMBODIMENTS

Embodiments of the present disclosure are described in more detail below with reference to the accompanying drawings. Although some embodiments of the present disclosure are shown in the drawings, it should be understood that the present disclosure may be implemented in various forms and should not be construed as being limited to the embodiments set forth herein. On the contrary, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that the concepts such as “first” and “second” mentioned in the present disclosure are only used to distinguish different apparatuses, modules, or units, and are not used to limit an order or interdependence of functions performed by these apparatuses, modules, or units.

It should be noted that the modifiers “one” and “a plurality of” mentioned in the present disclosure are illustrative and not restrictive, and those skilled in the art should understand that the modifiers should be understood as “one or more” unless the context clearly dictates otherwise.

Names of messages or information exchanged between a plurality of apparatuses in the implementations of the present disclosure are used for illustrative purposes only, and are not used to limit the scope of these messages or information.

It may be understood that, before the technical solutions disclosed in the embodiments of the present disclosure are used, the types, scope of use, usage scenarios, and the like, of the personal information involved in the present disclosure shall be notified to the user and the user's authorization shall be obtained in an appropriate manner according to relevant laws and regulations.

For example, when a user's active request is received, prompt information is sent to the user to explicitly prompt the user that an operation requested by the user will need to obtain and use the user's personal information. Therefore, the user can independently choose whether to provide personal information to a software or hardware such as an electronic device, an application, a server, or a storage medium that executes the operation of the technical solution of the present disclosure according to the prompt information.

As an optional but non-restrictive implementation, for example, the prompt information may be sent to the user in a pop-up window in response to receiving the user's active request. The prompt information may be presented in the pop-up window in text. In addition, the pop-up window may also carry a selection control for the user to select “Agree” or “Disagree” to provide personal information to the electronic device.

It may be understood that the above notification and obtaining of user authorization process are only schematic and do not limit the implementation of the present disclosure. Other methods that meet relevant laws and regulations may also be applied to the implementation of the present disclosure.

In addition, it may be understood that the data involved in the technical solution (including but not limited to the data itself, the acquisition or use of the data) shall comply with the requirements of corresponding laws, regulations, and related provisions.

In a programming language, an object is an abstraction of the objective world, and is a representation of the objective world in a computer. For example, a person or an object may be represented by an object in a computer. An object occupies memory and includes many attributes, and values of the attributes are stored in the memory occupied by the object. An attribute of the object may be an address of another object, that is, a pointer to another object, and another object may be referenced through the pointer.

An object being alive means that the object can be referenced through another alive object. If an object cannot be referenced through another alive object, the object cannot be accessed, and the memory space occupied by the object can be recollected and released. Otherwise, a memory leak will be caused, the memory will be exhausted, and the program will crash and cannot continue to run.

In the related art, there are many technologies for memory allocation and memory recollection. However, the inventors have found in long-term researches that in these memory allocation technologies, each time memory is allocated for an object, memory needs to be requested from an operating system or a memory management system at a lower layer, and then the memory is allocated. Because memory needs to be requested for many times, the memory allocation process is increased, and the memory allocation speed is reduced. In addition, in these memory recollection technologies, the recollection and cleaning logic is executed once for each unmarked object, to recollect the memory corresponding to the object. Because the recollection and cleaning logic needs to be executed for many times, the memory recollection process is increased, and the memory recollection and cleaning speed is reduced. It can be seen that the memory management methods in the related art have problems of slow memory allocation and slow memory recollection, resulting in low memory management efficiency.

In view of the above, embodiments of the present disclosure provide a memory management method and apparatus, a medium, and an electronic device in order to at least improve the memory allocation speed, thereby improving the memory management efficiency to a certain extent.

The following further describes the embodiments of the present disclosure with reference to the accompanying drawings.

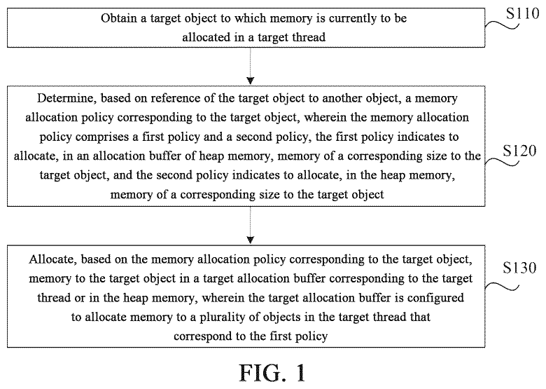

FIG. 1 is a flowchart of a memory management method according to an exemplary embodiment of the present disclosure. The memory management method may be applied to an electronic device. The electronic device herein may be, for example, a mobile phone, a tablet computer, or a notebook computer. Referring to FIG. 1, the memory management method includes the following steps:
S110: Obtain a target object to which memory is currently to be allocated in a target thread.
S120: Determine, based on reference of the target object to another object, a memory allocation policy corresponding to the target object, where the memory allocation policy includes a first policy and a second policy, the first policy indicates to allocate, in an allocation buffer of heap memory, memory of a corresponding size to the target object, and the second policy indicates to allocate, in the heap memory, memory of a corresponding size to the target object.
S130: Allocate, based on the memory allocation policy corresponding to the target object, memory to the target object in a target allocation buffer corresponding to the target thread or in the heap memory, where the target allocation buffer is configured to allocate memory to a plurality of objects in the target thread corresponding to the first policy.

The target thread may be a currently executed thread in the electronic device. It can be understood that the target thread may allocate a plurality of objects during execution, and the plurality of objects may be allocated memory in a preset order. Therefore, an object currently ready to be allocated memory in the target thread is the target object.

The heap memory is another memory area that is different from a stack area, a global data area, and a code area. The heap allows a thread to dynamically request a memory space of a specific size during execution. Therefore, the target allocation buffer may be understood as a larger memory space requested by the target thread in the heap memory.

In the embodiments of the present disclosure, after each target object is obtained, the memory allocation policy corresponding to the target object may be determined based on reference of the target object to another object. That is, it is determined, based on reference of the target object to another object, whether the memory allocation policy corresponding to the target object is the first policy or the second policy. In response to determining that the memory allocation policy is the first policy, free memory of a corresponding size is allocated to the target object in the target allocation buffer corresponding to the target thread. In response to determining that the memory allocation policy is the second policy, free memory of a corresponding size is allocated to the target object in the heap memory.

The free memory of a corresponding size may be allocated to the target object in the heap memory by using any memory allocation method in an existing memory management method.

In this way, the target object to which memory is currently to be allocated in the target thread is obtained, the memory allocation policy corresponding to the target object is determined based on reference of the target object to another object, and memory is allocated to, based on the memory allocation policy corresponding to the target object, the target object in the target allocation buffer corresponding to the target thread or in the heap memory. In this way, in addition to directly allocating, in the heap memory, memory of a corresponding size to the target object, a larger piece of memory may be requested in the heap memory, and the memory is used to allocate memory to a plurality of objects in the target thread corresponding to the first policy. Therefore, the process of allocating memory to the plurality of objects in the target thread corresponding to the first policy can be completed by requesting the target allocation buffer for one time, so that the number of times of requesting memory from an operating system or a memory management system at a lower layer can be reduced, and CPU usage of code related to memory management can be reduced. In addition, the memory allocation speed is improved, and the memory management efficiency is improved.

In addition, because the first policy is for allocating memory in the allocation buffer in the heap memory, the first policy may be considered as a fast path of the second policy, and the object memory allocation speed can be further improved. The memory allocation method different from the second policy in the related art is an optimization of the allocation method in the existing memory management method.

It can be seen from the above that when memory is recollected, if an object is referenced by an alive object, the object is also an alive object. In addition, in the embodiments of the present disclosure, the allocation buffer may be considered as a large object from the perspective of the heap memory. In the memory recollection stage, when at least one object in the allocation buffer is alive, the allocation buffer is alive. In this case, in order to reduce memory usage after memory is recollected, in some implementations, step S120 may include the following method steps:
determining, in response to the target object referencing another object, that the memory allocation policy corresponding to the target object is the second policy; and
determining, in response to the target object not referencing the other object, that the memory allocation policy corresponding to the target object is the first policy.

In some implementations, whether the target object references another object may be determined based on whether there is a pointer to another object in the target object. If there is a pointer to another object in the target object, it is determined that there is another referenced object in the target object. If there is no pointer to another object in the target object, it is determined that there is no referenced object in the target object.

The applicant has found in long-term researches that assuming that an object a containing a pointer is allocated in an allocation buffer, if there is an object b alive in the allocation buffer, the entire allocation buffer will be marked as alive. Therefore, regardless of whether the object a is actually alive, the object a is marked as alive, which may result in that an object pointed to by the object a is alive. Therefore, it is possible that due to marking the object a as alive, a bunch of objects that could have been recollected are also marked as alive, resulting in increased memory usage.

Therefore, in the embodiments of the present disclosure, in response to determining whether memory is allocated to the target object by using the first policy or the second policy, it may be determined whether the target object references another object. In response to determining that the target object references another object, it may be determined that the memory allocation policy corresponding to the target object is the second policy, and then free memory of a corresponding size is allocated to the target object in the heap memory. In response to determining that the target object does not reference another object, it may be determined that the memory allocation policy corresponding to the target object is the first policy.

In other words, by the above approach, only object that do not reference another object may be allocated in the allocation buffer, and for object that reference another object, memory may be normally allocated in the heap memory, thereby reducing memory usage after subsequent memory is recollected.

In addition, in some implementations, all target objects may be allocated memory by using the first policy without considering memory usage after the memory recollection stage. Alternatively, it is also possible to randomly select whether to allocate memory to the target object by using the first policy or the second policy.

In addition, considering that the memory management method may be executed to allocate memory to an object in the target thread by using the first policy for the first time, in this case, there may be a situation where the target allocation buffer has not been requested in the heap memory. Therefore, in some implementations, the method in the embodiments of the present disclosure may further include the following steps:
determining, based on an address of an allocation buffer associated with the target thread, whether the target allocation buffer is allocated for the target thread; and
in response to determining that the target allocation buffer is not allocated for the target thread, requesting, in the heap memory, a free memory space of a preset size as the target allocation buffer.

In the embodiments of the present disclosure, the target thread may be associated with an address of an allocation buffer. For example, a field corresponding to the address of the target allocation buffer may be included in information saved by the target thread, so that the address of the allocation buffer associated with the target thread can be obtained from the corresponding field, and it is then determined, based on the address of the allocation buffer associated with the target thread, whether the target allocation buffer is allocated for the target thread.

Exemplarily, if the associated address of the allocation buffer is a null value, it may be determined that the target allocation buffer is not allocated for the target thread. Therefore, a free memory space of a preset size may be requested in the heap memory as the target allocation buffer. If the associated address of the allocation buffer is not a null value, it may be determined that the target allocation buffer has been allocated for the target thread. Therefore, memory is directly allocated to the target object in the target allocation buffer corresponding to the target thread.

Optionally, the associated address of the allocation buffer may be any address in the allocation buffer, for example, a start address, a currently used address, or an end address.

In some implementations, the free memory space of a preset size may be, for example, a space area of 1 KB, 10 KB, 100 KB, or the like, which is set based on an actual requirement.

In addition, in some implementations, considering that a size of one allocation buffer is limited and cannot be used for allocating memory to the target object indefinitely, allocating memory to the target object in the target allocation buffer corresponding to the target thread in step S130 may include the following steps:
determining whether the free memory in the target allocation buffer supports allocating memory to the target object;
in response to determining that the free memory in the target allocation buffer supports allocating memory to the target object, allocating memory to the target object in the target allocation buffer; and
in response to determining that the free memory in the target allocation buffer does not support allocating memory to the target object, requesting, in the heap memory, a free memory space of a preset size as a new target allocation buffer, and allocating memory to the target object in the new target allocation buffer.

In the embodiments of the present disclosure, it may be first determined whether the free memory in the target allocation buffer supports allocating memory to the target object. If the free memory in the target allocation buffer supports allocating memory to the target object, memory is allocated to the target object in the target allocation buffer. If the free memory in the target allocation buffer does not support allocating memory to the target object, a free memory space of a preset size may be requested in the heap memory as a new target allocation buffer, and memory is allocated to the target object in the new target allocation buffer.

In some implementations, memory may be allocated to each target object in the target allocation buffer by using a pointer bumping method. In this case, whether the free memory in the target allocation buffer supports allocating memory to the target object may be determined by determining whether a sum of a currently used position in the target allocation buffer and an actual size of the target object is greater than an end position of the target allocation buffer.

The memory is allocated to the object by using the pointer bumping method, which can improve the object allocation speed. In addition, a locality principle of a program is used to place objects that may be accessed recently in time at adjacent positions in space, increasing a hit rate of a central processing unit (CPU) cache, thereby improving program performance.

An example is used below to illustratively describe allocating memory to the target object in the target allocation buffer corresponding to the target thread in the embodiments of the present disclosure.

Exemplarily, assuming that the target thread is t, an address of an allocation buffer associated with the thread t may be obtained. Further assuming that the obtained address is a null value, it is determined that the target allocation buffer is not allocated for the thread t. In this case, a memory space of 1 KB may be requested from the heap memory as the target allocation buffer corresponding to the thread t. In this case, the target allocation buffer may be marked by using three pointers, i.e., base, end, and top. The base represents a start address of the target allocation buffer, the end represents an end address of the target allocation buffer, and the top represents a currently used address of the target allocation buffer. In addition, a value of any pointer may be allocated to the address of the allocation buffer associated with the thread t, to indicate that the target allocation buffer has been allocated for the target thread.

In addition, in a case that memory is allocated to the target object in the target allocation buffer corresponding to the target thread, an actual size S′ of the object may be calculated based on the size of the object and a memory alignment rule, a value of S′+top may be calculated and compared with the end, thereby determining whether the free memory in the target allocation buffer supports allocating memory to the target object. If the value of S′+top is less than or equal to the value of the end, it is determined that the free memory in the target allocation buffer supports allocating memory to the target object, and then memory is allocated to the target object in the target allocation buffer. If the value of S′+top is greater than the value of the end, it is determined that the free memory in the target allocation buffer does not support allocating memory to the target object, and then a free memory space of 1 KB is requested again from the heap memory as the new target allocation buffer, and memory is allocated to each target object in the new target allocation buffer in the same manner.

If memory is allocated by using the pointer bumping method, in a case that memory is allocated in the target allocation buffer for the first time, the value of the top is equal to the value of the base, that is, memory is allocated from a start address of the allocation buffer. After the first object memory allocation is completed, the top is moved to a position of S′+base. In a case that memory is allocated in the target allocation buffer for the second time, memory is allocated from the moved position of the top. By analogy, until the value of S′+top is greater than the value of the end, the free memory space of 1 KB is requested again from the heap memory as the new target allocation buffer.

In some implementations, in addition to allocating memory to each target object in the target allocation buffer by using the pointer bumping method, memory may also be allocated to each target object in the target allocation buffer by randomly obtaining free memory.

It can be seen from the above that in some implementations, the memory allocation policy may include the first policy and the second policy. In this case, the memory allocation method in the embodiments of the present disclosure may further include the following steps:

In response to a preset memory recollection condition being met, marking a first object alive in the heap memory and a second object alive in the heap memory, where the first object is an object to which memory is allocated by using the first policy, and the second object is an object to which memory is allocated by using the second policy; and
recollecting, in the heap memory, the second object that is not marked and a candidate allocation buffer, where the candidate allocation buffer is an allocation buffer that does not include the marked first object.

In some implementations, the preset recollection condition may be met in a case that a memory usage rate reaches a set threshold or a specific memory recollection period is reached.

In the embodiments of the present disclosure, whether the first object or the second object is alive may be determined by determining whether the first object or the second object is referenced by another alive object as mentioned above.

After the first object alive in the heap memory and the second object alive in the heap memory are marked, the second object that is not marked in the heap memory and the candidate allocation buffer that does not include the marked first object may be further recollected.

In the embodiments of the present disclosure, because the candidate allocation buffer may be recollected as a whole, the recollection of a plurality of objects can be completed by only executing the recollection logic once, thereby reducing the number of times of executing the recollection and cleaning logic, improving the memory recollection and cleaning speed, and further improving the memory management efficiency.

There may be a plurality of situations in which there is no marked first object in the candidate allocation buffer. Optionally, all the first objects in the candidate allocation buffer are not alive during recollection, and in this case, the first objects in the candidate allocation buffer are not marked. Optionally, during recollection, some of the first objects in the candidate allocation buffer are alive, and some are not alive. The alive first objects are moved to another memory space in the heap memory by using a moving manner, so that none of the first objects in the candidate allocation buffer is marked.

As described above, considering that during recollection, some of the first objects in the candidate allocation buffer are alive, and some are not alive. The alive first objects are moved to another memory space in the heap memory by using a moving manner, so that none of the first objects in the candidate allocation buffer is marked. Therefore, in some implementations, the memory allocation method in the embodiments of the present disclosure may further include the following steps:

obtaining a total memory usage of the marked first object in the heap memory;

requesting, in the heap memory, a target memory space of a size of the total memory usage; and

moving the marked first object in the heap memory to the target memory space, to obtain the candidate allocation buffer.

In some implementations, the total memory usage of each marked first object may be counted in a cumulative manner when the first object alive in the heap memory is marked.

In the embodiments of the present disclosure, after the total memory usage of each marked first object in the heap memory is obtained, the target memory space of a size of the total memory usage may be requested in the heap memory. Then, each marked first object in the heap memory may be moved to the target memory space, so that there is no marked first object in the obtained candidate allocation buffer.

In the embodiments of the present disclosure, moving the marked first object in the heap memory can avoid memory fragmentation in the allocation buffer.

In some implementations, each marked first object may be moved with the help of an object

forwarding table and a pointer queue. The pointer queue stores addresses of pointers that simultaneously meet the following two conditions, for example, an address &x.f, where x.f represents a pointer. Assuming that the pointer x.f points to an object o, the first condition is that an object x that points to the object o is an alive object, and the second condition is that the object o pointed to by the x.f is in the target allocation buffer. The forwarding table records object movement. For example, if x.f->y is recorded in the forwarding table, it indicates that the object o has moved to a new address y.

An example is used below to describe the process of moving the marked first object in the heap memory to the target memory space.

A pointer address is sequentially taken out of a pointer queue (assuming that the pointer queue includes four pointer addresses &x1.f1, &x2.f2, &x3.f3, and &x4.f4, and the four pointer addresses respectively correspond to addresses of objects o1, o1, o2, and o2 in the allocation buffer). Assuming that the address &x1.f1 is taken out this time, the address &x1.f1 is dereferenced to obtain a pointer x1.f1, and the pointer points to an object o1. It is queried from the forwarding table whether the object o1 moves. If the object o1 does not move, the object o1 is moved to the target memory space based on an actual size of the object o1. After the moving, it is recorded in the object forwarding table that an address pointed to by the pointer x1.f1 moves from the address &x1.f1 to an address y.

Then, assuming that the address &x2.f2 is taken out for the second time, the address &x2.f2 is dereferenced to obtain a pointer x2.f2, and the pointer also points to the object o1. It is queried from the forwarding table that the object o1 has moved from the address &x1.f1 to the address y, which indicates that the object o1 pointed to by the pointer x2.f2 has moved, and there is no need to move the object o1 again. By analogy, the address &x3.f3 is taken out of the pointer queue again, to determine whether to move a dereferenced object o2, until all the addresses in the pointer queue are processed once, so that the marked first object in the heap memory is moved to the target memory space.

If memory is allocated to the target object in the target allocation buffer by using the pointer bumping method, the process of moving the object o1 to a position pointed to by the top of the target memory space based on the actual size of the object o1 is as follows:

A start address p of the object o1 is obtained based on a marked start address of the object during allocation. Because objects in the allocation buffer are allocated continuously, a size q of the object o1 can be obtained based on a start address p′ of an object adjacent to and after the object o1, and |p′-p|.

The x.f may not point to a start of the object o1. Based on the start address p of the object o1 and the x.f, |p-x.f| is an offset in the object o1, and is recorded as offset.

The object o1 is moved to a position pointed to by the top of the target memory space. If this is the first object to be moved, the top is a start position of the target memory space.

The x.f is modified to y, where y=top+offset, that is, the x.f points to the new memory address after the moving, so that the moving process of the marked first object is completed. In addition, the value of the top is modified to top+q, to facilitate the next moving.

In some implementations, there may be a plurality of marked first objects in the heap memory. In this case, a plurality of moving threads may be used to move the marked first objects in parallel, to speed up the recollection and cleaning process.

In some implementations, the memory allocated to the target object in the target allocation buffer is configured to sequentially store metadata of the target object and content of the target object. In response to the target object being referenced, a pointer referencing the target object points to a start address of the content of the target object.

In the embodiments of the present disclosure, in order to facilitate management of the memory in the allocation buffer, metadata may be added to the object of the allocation buffer, for example, to record information such as a start address, a size, and a forwarding table of the object. In this case, in order to enable the second object to normally reference the first object and make the first object more transparent from the perspective of the heap memory, the metadata may be further set before a start position of the content of the corresponding target object, and the pointer pointing to the target object is set to point to the start address of the content of the target object. Therefore, content corresponding to the object can be accurately obtained each time the target object is referenced, instead of the metadata.

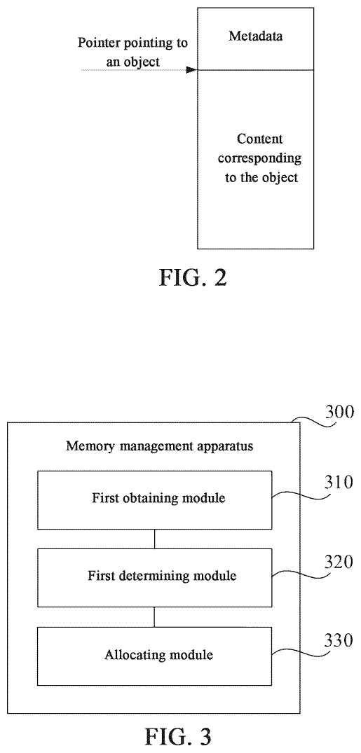

Exemplarily, as shown in FIG. 2, the target object includes the metadata and the content corresponding to the object. The metadata and the content corresponding to the object respectively occupy a memory space, and the pointer pointing to the target object points to the start address of the content corresponding to the object.

According to the method in the above embodiment, because the allocation buffer is a large object from the perspective of the heap memory, the execution of the program does not need to know details of the implementation of the allocation buffer, and the first object is transparent from the perspective of the heap memory. Therefore, when the memory allocation and memory recollection methods in any existing memory management method are used for allocation and recollection, the existence of the allocation buffer cannot be perceived, and the allocation buffer may be marked and recollected as a whole object. Therefore, it is not necessary to change the marking and recollection process of any existing memory management method, and no additional special processing is required, so that the process of allocating and moving the first object can be embedded into any existing memory management method. In addition, objects allocated by using the first policy and the second policy may have different object layouts. For example, an object allocated by using the second policy may not include metadata, and an object allocated by using the first policy may include metadata. However, objects allocated by using the two policies are consistent at the memory management level. Therefore, an object allocated by using the first policy may be managed by using the first policy and the second policy at the same time, and objects allocated by using different policies may reference each other.

FIG. 3 is a block diagram of a memory management apparatus according to an exemplary embodiment of the present disclosure. Referring to FIG. 3, the memory management apparatus 300 includes:
a first obtaining module 310, configured to obtain a target object to which memory is currently to be allocated in a target thread;
a first determining module 320, configured to determine, based on reference of the target object to another object, a memory allocation policy corresponding to the target object, where the memory allocation policy includes a first policy and a second policy, the first policy indicates to allocate, in an allocation buffer of heap memory, memory of a corresponding size to the target object, and the second policy indicates to allocate, in the heap memory, memory of a corresponding size to the target object; and
an allocating module 330, configured to allocate, based on the memory allocation policy corresponding to the target object, memory to the target object in a target allocation buffer corresponding to the target thread or in the heap memory, where the target allocation buffer is configured to allocate memory to a plurality of objects in the target thread corresponding to the first policy.

Optionally, the first determining module 320 is further configured to determine, in response to the target object referencing another object, that the memory allocation policy corresponding to the target object is the second policy; and determine, in response to the target object not referencing another object, that the memory allocation policy corresponding to the target object is the first policy.

Optionally, the apparatus 300 further includes:
a second determining module, configured to determine, based on an address of an allocation buffer associated with the target thread, whether the target allocation buffer is allocated for the target thread; and
a target allocation buffer requesting module, configured to request, in the heap memory, a free memory space of a preset size as the target allocation buffer in response to determining that the target allocation buffer is not allocated for the target thread.

Optionally, the allocating module 330 includes:
a determining submodule, configured to determine whether the free memory in the target allocation buffer supports allocating memory to the target object;
a first allocation submodule, configured to allocate memory to the target object in the target allocation buffer in response to determining that the free memory in the target allocation buffer supports allocating memory to the target object; and
a second allocation submodule, configured to request, in the heap memory, a free memory space of a preset size as a new target allocation buffer in response to determining that the free memory in the target allocation buffer does not support allocating memory to the target object, and allocate memory to the target object in the new target allocation buffer.

Optionally, the apparatus 300 further includes:
a marking module, configured to mark a first object alive in the heap memory and a second object alive in the heap memory in response to a preset memory recollection condition being met, where the first object is an object to which memory is allocated by using the first policy, and the second object is an object to which memory is allocated by using the second policy; and
a recollection module, configured to recollect, in the heap memory, the second object that is not marked and a candidate allocation buffer, where the candidate allocation buffer is an allocation buffer that does not include the marked first object.

Optionally, the apparatus 300 further includes:
a second obtaining module, configured to obtain a total memory usage of the marked first object in the heap memory;
a target memory space requesting module, configured to request, in the heap memory, a target memory space of a size of the total memory usage; and
a moving module, configured to move the marked first object in the heap memory to the target memory space, to obtain the candidate allocation buffer.

Optionally, the memory allocated to the target object in the target allocation buffer is configured to sequentially store a metadata of the target object and content of the target object. In response to the target object being referenced, a pointer referencing the target object points to a start address of the content of the target object.

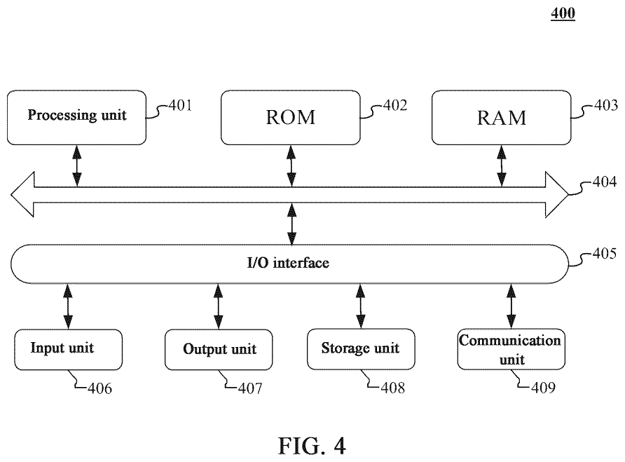

Reference is made to FIG. 4 below, which is a schematic diagram of a structure of an electronic device 400 suitable for implementing the embodiments of the present disclosure. The terminal device in the embodiments of the present disclosure may include, but may be not limited to, mobile terminals such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and fixed terminals such as a digital TV and a desktop computer. The electronic device shown in FIG. 4 is merely an example, and shall not impose any limitation on the function and scope of use of the embodiments of the present disclosure.

As shown in FIG. 4, the electronic device 400 may include a processing unit (for example, a central processing unit, a graphics processing unit, etc.) 401 that may perform a variety of appropriate actions and processing according to a program stored in a read-only memory (ROM) 402 or a program loaded from a storage unit 408 to a random access memory (RAM) 403. The RAM 403 further stores various programs and data required for the operation of the electronic device 400. The processing unit 401, the ROM 402, and the RAM 403 are connected to each other through a bus 404. An input/output (I/O) interface 405 is also connected to the bus 404.

Generally, the following apparatuses may be connected to the I/O interface 405: an input unit 406 including, for example, a touchscreen, a touchpad, a keyboard, a mouse, a camera, a microphone, an accelerometer, and a gyroscope; an output unit 407 including, for example, a liquid crystal display (LCD), a speaker, and a vibrator; the storage unit 408 including, for example, a tape and a hard disk; and a communication unit 409. The communication unit 409 may allow the electronic device 400 to perform wireless or wired communication with other devices to exchange data. Although FIG. 4 shows the electronic device 400 having various apparatuses, it should be understood that it is not required to implement or have all the shown apparatuses. It may be an alternative to implement or have more or fewer apparatuses.

In particular, according to an embodiment of the present disclosure, the process described above with reference to the flowcharts may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded from a network through the communication unit 409 and installed, installed from the storage unit 408, or installed from the ROM 402. When the computer program is executed by the processing unit 401, the above-mentioned functions defined in the method of the embodiment of the present disclosure are performed.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but may be not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, the electronic device may communicate using any currently known or future-developed network protocol such as a HyperText Transfer Protocol (HTTP), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to: obtain a target object to which memory is currently to be allocated in a target thread; determine a memory allocation policy corresponding to the target object, where the memory allocation policy includes a first policy of allocating memory to the target object in an allocation buffer of heap memory; and in response to determining that the memory allocation policy is the first policy, allocate memory to the target object in a target allocation buffer corresponding to the target thread, where the target allocation buffer is configured to allocate memory to a plurality of objects in the target thread corresponding to the first policy.

The computer program code for performing the operations of the present disclosure may be written in one or more programming languages or a combination thereof, where the programming languages include, but are not limited to, an object-oriented programming language, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of a remote computer, the remote computer may be connected to a computer of a user through any type of network, including a local area network (LAN) or a wide area network (WAN), or may be connected to an external computer (for example, connected through the Internet using an Internet service provider).

The flowcharts and block diagrams in the accompanying drawings illustrate possible system architectures, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession may actually be executed substantially in parallel, or they may sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The modules described in the embodiments of the present disclosure may be implemented by software, or may be implemented by hardware. The name of a module does not in some cases constitute a limitation on the module itself.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system on chip (SOC), a complex programmable logic device (CPLD), and the like.

In the context of the present disclosure, a machine-readable medium may be a tangible medium that may contain or store a program for use by or in combination with an instruction execution system, apparatus, or device. The machine-readable medium may be a machine-readable signal medium or a machine-readable storage medium. The machine-readable medium may include, but may be not limited to, electronic, magnetic, optical, electromagnetic, infrared, or semiconductor systems, apparatuses, or devices, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

According to one or more embodiments of the present disclosure, Example 1 provides a memory management method, the method including:
obtaining a target object to which memory is currently to be allocated in a target thread;
determining, based on reference of the target object to another object, a memory allocation policy corresponding to the target object, where the memory allocation policy includes a first policy and a second policy, the first policy indicates to allocate, in an allocation buffer of heap memory, memory of a corresponding size to the target object, and the second policy indicates to allocate, in the heap memory, memory of a corresponding size to the target object; and
allocating, based on the memory allocation policy corresponding to the target object, memory to the target object in a target allocation buffer corresponding to the target thread or in the heap memory, where the target allocation buffer is configured to allocate memory to a plurality of objects in the target thread corresponding to the first policy.

According to one or more embodiments of the present disclosure, Example 2 provides the method of Example 1, where the determining a memory allocation policy corresponding to the target object includes:
determining, in response to the target object referencing another object, that the memory allocation policy corresponding to the target object is the second policy; and
determining, in response to the target object not referencing another object, that the memory allocation policy corresponding to the target object is the first policy.

According to one or more embodiments of the present disclosure, Example 3 provides the method of Example 1, where the method further includes:
determining, based on an address of an allocation buffer associated with the target thread, whether the target allocation buffer is allocated for the target thread; and
in response to determining that the target allocation buffer is not allocated for the target thread, requesting, in the heap memory, a free memory space of a preset size as the target allocation buffer.

According to one or more embodiments of the present disclosure, Example 4 provides the method of Example 1, where the allocating memory to the target object in the target allocation buffer corresponding to the target thread includes:
determining whether the free memory in the target allocation buffer supports allocating memory to the target object;
in response to determining that the free memory in the target allocation buffer supports allocating memory to the target object, allocating memory to the target object in the target allocation buffer; and
in response to determining that the free memory in the target allocation buffer does not support allocating memory to the target object, requesting, in the heap memory, a free memory space of a preset size as a new target allocation buffer, and allocating memory to the target object in the new target allocation buffer.

According to one or more embodiments of the present disclosure, Example 5 provides the method of Example 1, where the method further includes:
marking a first object alive in the heap memory and a second object alive in the heap memory in response to a preset memory recollection condition being met, where the first object is an object to which memory is allocated by using the first policy, and the second object is an object to which memory is allocated by using the second policy; and
recollecting, in the heap memory, the second object that is not marked and a candidate allocation buffer, where the candidate allocation buffer is an allocation buffer that does not include the marked first object.

According to one or more embodiments of the present disclosure, Example 6 provides the method of Example 5, where the method further includes:
obtaining a total memory usage of the marked first object in the heap memory;
requesting, in the heap memory, a target memory space of a size of the total memory usage; and
moving the marked first object in the heap memory to the target memory space, to obtain the candidate allocation buffer.

According to one or more embodiments of the present disclosure, Example 7 provides the method of Example 1, where the memory allocated to the target object in the target allocation buffer is configured to sequentially store metadata of the target object and content of the target object. In response to the target object being referenced, a pointer referencing the target object points to a start address of the content of the target object.

According to one or more embodiments of the present disclosure, Example 8 provides a memory management apparatus, the apparatus including:
a first obtaining module, configured to obtain a target object to which memory is currently to be allocated in a target thread;
a first determining module, configured to determine, based on reference of the target object to another object, a memory allocation policy corresponding to the target object, where the memory allocation policy includes a first policy and a second policy, the first policy indicates to allocate, in an allocation buffer of heap memory, memory of a corresponding size to the target object, and the second policy indicates to allocate, in the heap memory, memory of a corresponding size to the target object; and
an allocating module, configured to allocate, based on the memory allocation policy corresponding to the target object, memory to the target object in a target allocation buffer corresponding to the target thread or in the heap memory, where the target allocation buffer is configured to allocate memory to a plurality of objects in the target thread corresponding to the first policy.

According to one or more embodiments of the present disclosure, Example 9 provides a computer-readable medium having a computer program stored thereon, where the computer program when executed by a processing unit, implements the steps of the method according to any of Examples 1 to 7.

According to one or more embodiments of the present disclosure, Example 10 provides an electronic device, including:
a storage having a computer program stored thereon; and
a processing unit configured to execute the computer program in the storage to implement the steps of the method according to any of Examples 1 to 7.

The foregoing descriptions are merely preferred embodiments of the present disclosure and explanations of the applied technical principles. Persons skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by replacing the foregoing features with technical features having similar functions disclosed in the present disclosure (but not limited thereto).

In addition, although the various operations are depicted in a specific order, it should be understood as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in a single embodiment can also be implemented in a plurality of embodiments individually or in any suitable sub-combination.

Although the subject matter has been described in a language specific to structural features and/or logical actions of the method, it should be understood that the subject matter specified in the appended claims is not necessarily limited to the specific features or actions described above. In contrast, the specific features and actions described above are merely exemplary forms of implementing the claims. For the apparatuses in the foregoing embodiments, the specific manners in which the respective modules perform operations have been described in detail in the embodiments relating to the method, and will not be elaborated here.

1. A memory management method, the method comprising:
obtaining a target object to which memory is currently to be allocated in a target thread;
determining, based on reference of the target object to another object, a memory allocation policy corresponding to the target object, the memory allocation policy comprising a first policy and a second policy, the first policy indicating to allocate, in an allocation buffer of heap memory, memory of a corresponding size to the target object, and the second policy indicating to allocate, in the heap memory, memory of a corresponding size to the target object; and
allocating, based on the memory allocation policy corresponding to the target object, memory to the target object in a target allocation buffer corresponding to the target thread or in the heap memory, the target allocation buffer being configured to allocate memory to a plurality of objects in the target thread corresponding to the first policy.

2. The method of claim 1, wherein determining, based on the reference of the target object to the other object, the memory allocation policy corresponding to the target object comprises:
determining, in response to the target object referencing the other object, that the memory allocation policy corresponding to the target object is the second policy; and
determining, in response to the target object not referencing the other object, that the memory allocation policy corresponding to the target object is the first policy.

3. The method of claim 1, wherein the method further comprises:
determining, based on an address of an allocation buffer associated with the target thread, whether the target allocation buffer is allocated for the target thread; and
in response to determining that the target allocation buffer is not allocated for the target thread, requesting, in the heap memory, a free memory space of a preset size as the target allocation buffer.

4. The method of claim 1, wherein allocating the memory to the target object in the target allocation buffer corresponding to the target thread comprises:
determining whether the free memory in the target allocation buffer supports allocating memory to the target object;
in response to determining that the free memory in the target allocation buffer supports allocating memory to the target object, allocating memory to the target object in the target allocation buffer; and
in response to determining that the free memory in the target allocation buffer does not support allocating memory to the target object, requesting, in the heap memory, a free memory space of a preset size as a new target allocation buffer, and allocating memory to the target object in the new target allocation buffer.

5. The method of claim 1, the method further comprising:
marking a first object alive in the heap memory and a second object alive in the heap memory in response to determining that a preset memory recovery condition is met, wherein the first object is an object to which memory is allocated by using the first policy, and the second object is an object to which memory is allocated by using the second policy; and
recollecting, in the heap memory, the second object which is not marked and a candidate allocation buffer, wherein the candidate allocation buffer is an allocation buffer which does not include the marked first object.

6. The method of claim 5, the method further comprising:
obtaining a total memory usage of the marked first object in the heap memory;
requesting, in the heap memory, a target memory space of a size of the total memory usage; and
moving the marked first object in the heap memory to the target memory space, to obtain the candidate allocation buffer.

7. The method of claim 1, wherein the memory allocated to the target object in the target allocation buffer is configured to sequentially store a metadata of the target object and a content of the target object, and wherein, in response to determining that the target object is referenced, a pointer referencing the target object points to a start address of the content of the target object.

8. (canceled)

9. A non-transitory computer-readable medium having a computer program stored thereon, wherein the computer program when executed by a processor, cause the processor to:
obtain a target object to which memory is currently to be allocated in a target thread;
determine, based on reference of the target object to another object, a memory allocation policy corresponding to the target object, the memory allocation policy comprising a first policy and a second policy, the first policy indicating to allocate, in an allocation buffer of heap memory, memory of a corresponding size to the target object, and the second policy indicating to allocate, in the heap memory, memory of a corresponding size to the target object; and
allocate, based on the memory allocation policy corresponding to the target object, memory to the target object in a target allocation buffer corresponding to the target thread or in the heap memory, the target allocation buffer being configured to allocate memory to a plurality of objects in the target thread corresponding to the first policy.

10. An electronic device, the electronic device comprising:
a storage having a computer program stored thereon; and
a processor configured to execute the computer program in the storage, wherein the computer program, when executed by the processor, cause the processor to:
obtain a target object to which memory is currently to be allocated in a target thread;
determine, based on reference of the target object to another object, a memory allocation policy corresponding to the target object, the memory allocation policy comprising a first policy and a second policy, the first policy indicating to allocate, in an allocation buffer of heap memory, memory of a corresponding size to the target object, and the second policy indicating to allocate, in the heap memory, memory of a corresponding size to the target object; and
allocate, based on the memory allocation policy corresponding to the target object, memory to the target object in a target allocation buffer corresponding to the target thread or in the heap memory, the target allocation buffer being configured to allocate memory to a plurality of objects in the target thread corresponding to the first policy.

11. The non-transitory computer-readable medium of claim 9, wherein the computer program that causes the processor to determine, based on the reference of the target object to the other object, the memory allocation policy corresponding to the target object comprises instructions to:
determine, in response to the target object referencing the other object, that the memory allocation policy corresponding to the target object is the second policy; and
determine, in response to the target object not referencing the other object, that the memory allocation policy corresponding to the target object is the first policy.

12. The non-transitory computer-readable medium of claim 9, wherein the processor is further caused to:
determine, based on an address of an allocation buffer associated with the target thread, whether the target allocation buffer is allocated for the target thread; and
in response to determining that the target allocation buffer is not allocated for the target thread, request, in the heap memory, a free memory space of a preset size as the target allocation buffer.

13. The non-transitory computer-readable medium of claim 9, wherein the computer program that causes the processor to allocate the memory to the target object in the target allocation buffer corresponding to the target thread comprises instructions to:
determine whether the free memory in the target allocation buffer supports allocating memory to the target object;
in response to determining that the free memory in the target allocation buffer supports allocating memory to the target object, allocate memory to the target object in the target allocation buffer; and
in response to determining that the free memory in the target allocation buffer does not support allocating memory to the target object, request, in the heap memory, a free memory space of a preset size as a new target allocation buffer, and allocating memory to the target object in the new target allocation buffer.

14. The non-transitory computer-readable medium of claim 9, the processor is further caused to:
mark a first object alive in the heap memory and a second object alive in the heap memory in response to determining that a preset memory recovery condition is met, wherein the first object is an object to which memory is allocated by using the first policy, and the second object is an object to which memory is allocated by using the second policy; and
recollect, in the heap memory, the second object which is not marked and a candidate allocation buffer, wherein the candidate allocation buffer is an allocation buffer which does not include the marked first object.

15. The non-transitory computer-readable medium of claim 14, the processor is further caused to:
obtain a total memory usage of the marked first object in the heap memory;
request, in the heap memory, a target memory space of a size of the total memory usage; and
move the marked first object in the heap memory to the target memory space, to obtain the candidate allocation buffer.

16. The non-transitory computer-readable medium of claim 9, wherein the memory allocated to the target object in the target allocation buffer is configured to sequentially store a metadata of the target object and a content of the target object, and wherein, in response to determining that the target object is referenced, a pointer referencing the target object points to a start address of the content of the target object.

17. The electronic device of claim 10, wherein the computer program that causes the processor to determine, based on the reference of the target object to the other object, the memory allocation policy corresponding to the target object comprises instructions to:
determine, in response to the target object referencing the other object, that the memory allocation policy corresponding to the target object is the second policy; and
determine, in response to the target object not referencing the other object, that the memory allocation policy corresponding to the target object is the first policy.

18. The electronic device of claim 10, wherein the processor is further caused to:
determine, based on an address of an allocation buffer associated with the target thread, whether the target allocation buffer is allocated for the target thread; and
in response to determining that the target allocation buffer is not allocated for the target thread, request, in the heap memory, a free memory space of a preset size as the target allocation buffer.

19. The electronic device of claim 10, wherein the computer program that causes the processor to allocate the memory to the target object in the target allocation buffer corresponding to the target thread comprises instructions to:
determine whether the free memory in the target allocation buffer supports allocating memory to the target object;
in response to determining that the free memory in the target allocation buffer supports allocating memory to the target object, allocate memory to the target object in the target allocation buffer; and
in response to determining that the free memory in the target allocation buffer does not support allocating memory to the target object, request, in the heap memory, a free memory space of a preset size as a new target allocation buffer, and allocating memory to the target object in the new target allocation buffer.

20. The electronic device of claim 10, the processor is further caused to:
mark a first object alive in the heap memory and a second object alive in the heap memory in response to determining that a preset memory recovery condition is met, wherein the first object is an object to which memory is allocated by using the first policy, and the second object is an object to which memory is allocated by using the second policy; and
recollect, in the heap memory, the second object which is not marked and a candidate allocation buffer, wherein the candidate allocation buffer is an allocation buffer which does not include the marked first object.

21. The electronic device of claim 10, wherein the memory allocated to the target object in the target allocation buffer is configured to sequentially store a metadata of the target object and a content of the target object, and wherein, in response to determining that the target object is referenced, a pointer referencing the target object points to a start address of the content of the target object.
